(19) United States
(12) Patent Application Publication
(10) Pub. No.: US 2007/0127403 A1
(43) Pub. Date: Jun. 7, 2007

(54) Power saving method for WLAN station

(75) Inventors: Hokeng Lu, Hsinchu City (TW); Chih-hao Yeh, Yonghe City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Inc.

(21) Appl. No.: 11/294,788

(22) Filed: Dec. 6, 2005

(51) Int. Cl. G08C 17/00

(52) U.S. Cl. 370/311

(57) ABSTRACT

A power saving method is provided, implemented in a station operative in WLAN to receive packets from an access point. The station comprises a RF module, a baseband module, a MAC module, a processor and an ASIC. The RF module demodulates received radio signals into basedband signals. The baseband module coupled to the RF module converts the baseband signals to a bit stream. The MAC module coupled to the baseband module processes the bit stream to obtain data packets. The processor coupled to the MAC module receives the data packets to perform networking operations. The ASIC, coupled to the baseband module, MAC module, and processor, performs a power saving mode operation.

### FIELD OF THE INVENTION

The present invention relates to wireless local area networking (WLAN), and in particular, to a power saving method for a station in the WLAN.

### DESCRIPTION OF THE RELATED ART

FIG. la shows a conventional station schematic diagram. An RF module 102 demodulates received radio signals from an antenna to generate basedband signals. A baseband module 104 coupled to the RF module 102 converts the baseband signals into a bit stream. A MAC module 106 coupled to the baseband module 104 processes the bit stream to obtain data packets. A processor 108 coupled to the MAC module 106 receives the data packets and performs networking operations. The baseband module 104 and MAC module 106 are typically implemented in one chip, in which the baseband module 104 functions as a physical layer block and the MAC module 106 is a media access control layer block. The processor 108 utilizes software and read only memory (ROM) to perform network operations in application layers. The IEEE 802.11 standard has specified a power management scheme. When a station's network usage is below a threshold, the station directs the access point to enter a power saving mode, and the RF module 102, baseband module 104, MAC module 106 and processor 108 switch to a sleep state to minimize power consumption. When packets bound for the station are generated, the packets are queued in the access point. The access point delivers a beacon frame periodically to synchronize with the sleeping station, and the beacon frame comprises a TIM field indicating whether there are queued packets for the station. The sleeping station periodically restores to receive the beacon frame, and determines whether to receive the queued packets according to the TIM field.

FIG. 1b is a flowchart of a conventional power saving mode operation. In step 110, the station switches to a power saving mode. A wake period is set in a timing synchronization function (TSF), and a target beacon transmit time (TBTT) is configured as an offset in the wake period. The RF module 102, baseband module 104, MAC module 106 and processor 108 then sleep to reduce power consumption. In step 120, the TSF times the sleeping period, and the station remains asleep until the TBTT is reached. In step 130, at the TBTT, the RF module 102, baseband module 104, MAC module 106, and processor 108 wake to receive the beacon frame. A beacon frame provides information for the station to maintain synchronization while in the power saving mode. In step 140, the processor 108 then detects whether there are packets queued according to a TIM field in the beacon frame. If the TIM field indicates no packets, the RF module 102, baseband module 104, MAC module 106 and processor 108 return to sleep and the process returns to step 120. If the TIM field indicates multicast/broadcast packets to receive, the process goes to step 145, and the processor 108 performs corresponding operations to receive the packets. Also, if the TIM field indicates unicast packets to receive, the process goes to step 150, in which the processor 108 delivers a poll frame to request the packets. When steps 145 and 150 are complete, the process returns to step 110, and the RF module 102, baseband module 104, MAC module 106 and processor 108 in the station return to the sleep state.

FIG. 2 is a timing diagram showing power consumption of a conventional station. When the RF module 102, baseband module 104, MAC module 106 and processor 108 sleep in step 110, total power consumption is Ps. When the timing calculated by the TSF approaches TBTT in step 120, the processor 108 wakes to initialize the RF module 102, baseband module 104 and MAC module 106, such that power consumed is Pcpu. The processor 108 controls the RF module 102, baseband module 104, and MAC module 106 to receive a beacon frame in step 130, and confirms the TIM field in step 140, rendering slightly higher power consumption Prx. If a receiving operation is initialized based on the indication of TIM field, such as steps 145 and 150, power consumption Pw significantly increases. Power consumption Pcpu receiving a beacon, however, may be considered inefficient since the operation is performed by the processor 108 executing an operating system and software. A more efficient implementation is desirable to economize the power consumption Pcpu.

### BRIEF SUMMARY OF INVENTION

A detailed description is given in the following embodiments with reference to the accompanying drawings.

An exemplary embodiment of power saving method is provided, implemented in a WLAN station to receive packets from an access point. The station comprises a RF module, a baseband module, a MAC module, a processor. and an ASIC. The RF module demodulates received radio signals into basedband signals. The baseband module coupled to the RF module converts the baseband signals to a bit stream. The MAC module coupled to the baseband module processes the bit stream to obtain data packets. The processor coupled to the MAC module receives the data packets to perform networking operations. The ASIC coupled to the baseband module, MAC module and processor, performs a power .saving mode operation.

The ASIC switches the RF module, baseband module, MAC module and processor to a sleep state. The ASIC periodically wakes the RF module, baseband module and MAC module to monitor a beacon frame comprising a TIM field. The ASIC determines whether the packets are available for receipt according to the TIM field. If so, the ASIC wakes the processor to perform the reception operation.

If the beacon frame is not received within a timeout interval, the ASIC wakes the processor to handle the timeout event. If the TIM field indicates that there are unicast packets available for receipt, the ASIC waking the processor to send a poll frame to request the unicast packets.

If the TIM field indicates that a broadcast packet is available for receipt, the RF module, baseband module, and MAC module receive the broadcast packet, and the ASIC determines whether the broadcast packet matches a specific pattern. If so, the ASIC wakes the processor to perform corresponding processes. If not, the ASIC determines whether the broadcast packet comprises a more-bit set to 1.

If the more-bit is set to 1, the process returns to the RF module, baseband module and MAC module receiving the broadcast packet and the ASIC matching the specific pattern therewith. If the more-bit is set to 0, the process returns to the ASIC switching the RF module, baseband module and MAC module to the sleep state.

### BRIEF DESCRIPTION OF DRAWINGS

The invention can be more fully understood by reading the subsequent detailed description and examples with references made to the accompanying drawings, wherein:

FIG. 1a shows a conventional station schematic diagram;

FIG. 1b is a flowchart of a conventional power saving mode operation;

FIG. 2 is a timing diagram showing power consumption of the conventional station;

FIG. 3 is a schematic diagram showing an embodiment. of a station; and

FIG. 4 is a flowchart of the power saving method according to the invention.

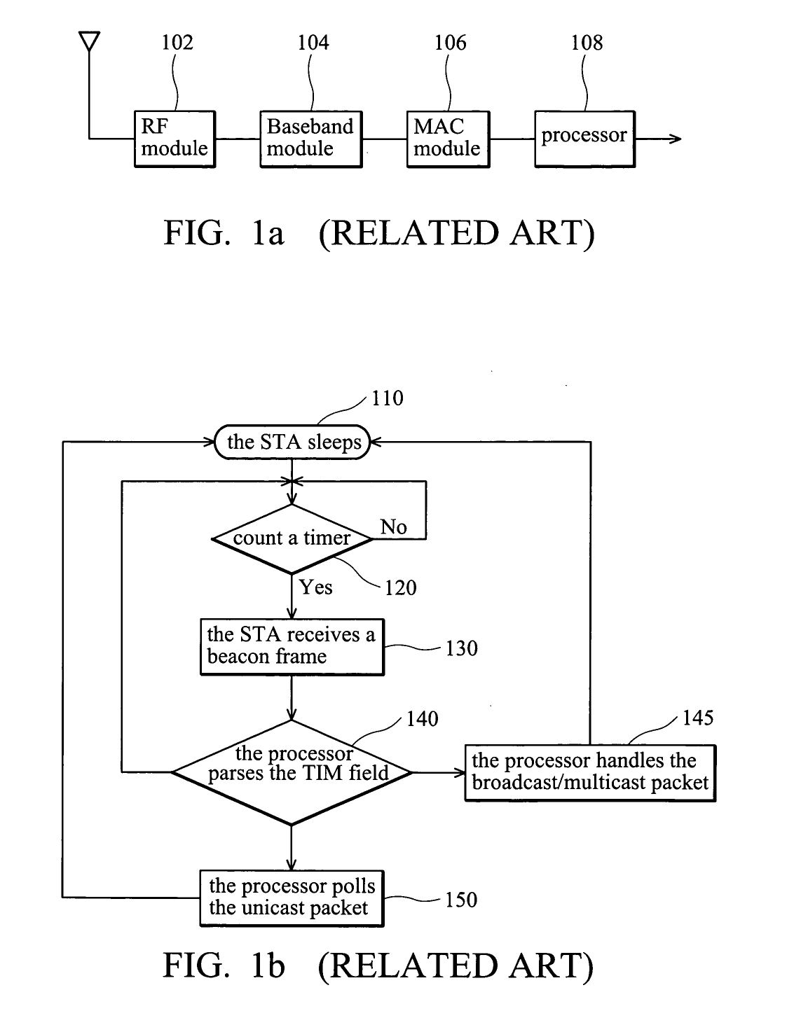

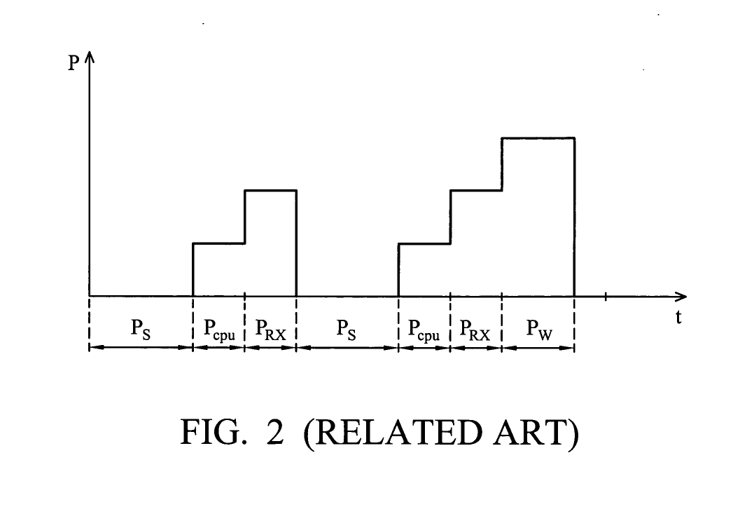

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

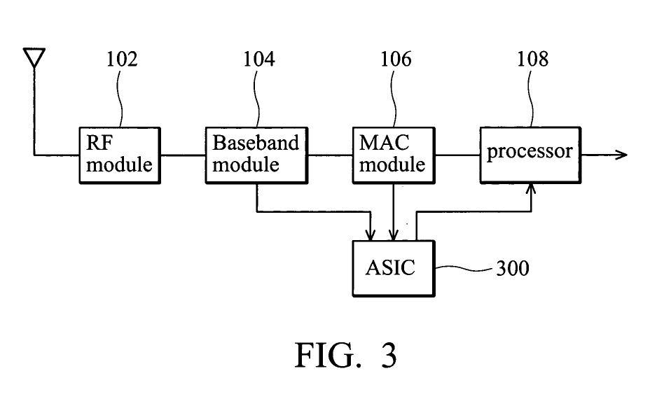

FIG. 3 is a schematic diagram showing an embodiment of a station. An ASIC 300 is provided to perform the power saving mode operation, such that the processor 108 is not required to wake to parse a beacon frame. Since the ASIC 300 is an optimized component for the operation, power consumption is significantly lower than the Pcpu. When the station enters the power saving mode, the RF module 102, baseband module 104, MAC module 106 and processor 108 switch to the sleep state, and the ASIC 300 switches to a slow clock to continue timing. At TBTT, the ASIC 300 wakes the RF module 102, baseband module 104 and MAC module 106 to receive a beacon frame, and parses the beacon frame to determine whether it is necessary to wake the processor 108 for further operation. The TIM field in a beacon frame may indicate the presence of unicast packets or broadcast/multicast packets queued for the station. In response to the TIM field indication, the station may deliver a poll frame to the access point to request the unicast packets. The broadcast/multicast packets are sent following the beacon frame, and the station decides whether to receive or not. The ASIC 300 also provides a matching mechanism that further determines whether a broadcast/multicast packet to be received, such that only necessary packets are received and unnecessary packets discarded, with receiving operations performed by the processor 108 reduced.

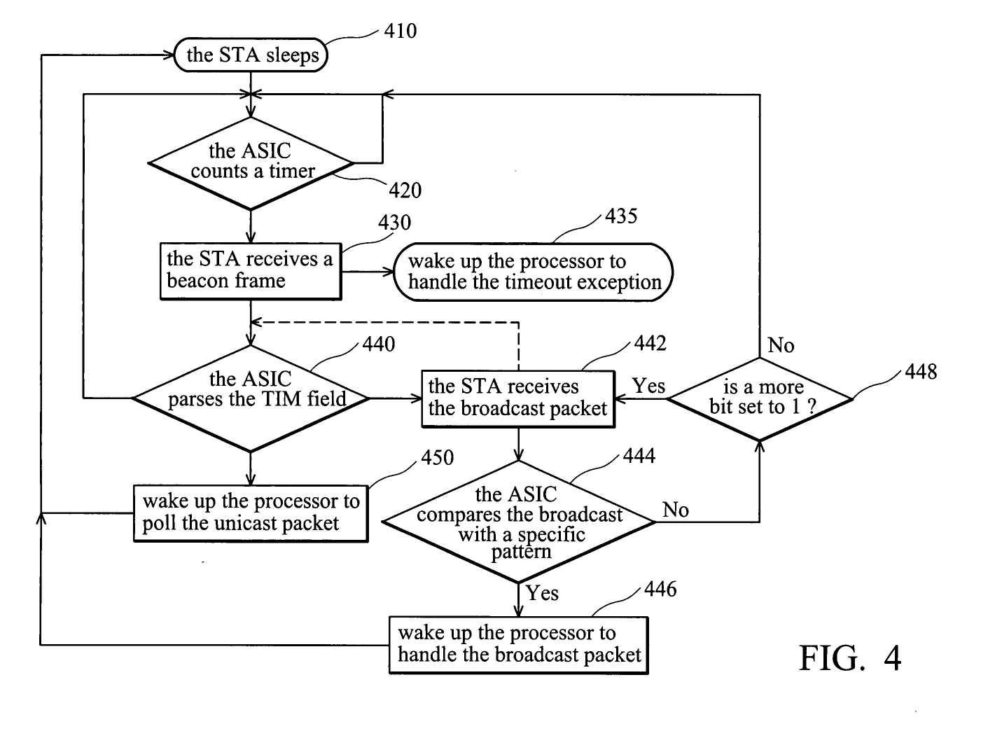

FIG. 4 is a flowchart of the power saving method according to the invention. In step 410, the station initializes the power saving mode by sending a notification to the access point, and the RF module 102, baseband module 104, MAC module 106 and processor 108 are switched to a sleep state. The ASIC 300 switches to a slow clock to continue timing. The wake period and wake time TBTT are configured when entering the power saving mode. In step 420, the timing counter loops until the wake time TBTT is reached, and step 430 is processed, in which the ASIC 300 wakes the RF module 102, baseband module 104 and MAC module 106 to receive a beacon frame. If the beacon frame is not received within a predetermined timeout period, the processor 108 is awakened to handle the exception in step 435. In step 440, when a beacon frame is received, the ASIC 300 parses a TIM field in the beacon frame to determine whether there are queued packets to receive. In most cases, no packet is queued, so the RF module 102, baseband module 104 and MAC module 106 return to the sleep state, and the process returns to step 420, idling for another period. In step 440, If the TIM field indicates that a unicast packet is available, step 450 is processed. In step 450, the ASIC 300 wakes the processor 108 to perform a polling operation, in which a poll frame is sent to the access point to request the unicast packet. Alternatively in step 440, if the TIM field indicates that a broadcast (or multicast) packet is available, step 442 is processed. In step 442, the ASIC 300 wakes the RF module 102, baseband module 104 and MAC module 106 to receive the broadcast packet. In step 444, the ASIC 300 parses the received broadcast packet to determine whether a specific pattern is matched. Since most of the broadcast packets are unneeded, they are discarded without reception. The specific pattern is defined to rapidly determine whether a broadcast packet is useful for the station. If the specific pattern is not matched, the process goes to step 448. If the specific pattern matches. a received broadcast packet, step 446 is processed, in which the processor 108 is awakened to handle the broadcast packet, and thereafter, the processor 108 sleeps and the process goes to step 410. The access point may broadcast consecutive packets sequentially, and each broadcast packet comprises a more-bit indicating whether a successive broadcast packet is available. In step 448, the ASIC 300 determines whether the more-bit is set to 1. If the more-bit is 1, the process returns to step 442 to parse another broadcast packet. Otherwise, the process returns to step 420, and the RF module 102, baseband module 104 and MAC module 106 return to the sleep state. While the station receives the broadcast packets in step 442, the duration may exceed the wake period, whereby another beacon frame is initiated. In this case, the process returns to step 440 to handle the newly arrived beacon frame.

While the invention has been described by way of example and in terms of preferred embodiment, it is to be understood that the invention is not limited thereto. To the contrary, it is intended to cover various modifications and similar: arrangements (as would be apparent to those skilled in the art). Therefore, the scope of the appended claims should be accorded the broadest interpretation so as to encompass all such modifications and similar arrangements.

What is claimed is:

1. A station (STA) in a wireless local area network (WLAN) to receive packets from an access point (AP) in a power saving mode, comprising:
a radio frequency (RF) module, demodulating received radio signals into basedband signals;
a baseband module, coupled to the RF module, converting the baseband signals to a bit stream;
a media access control (MAC) module, coupled to the baseband module, processing the bit stream to obtain data packets;
a processor, coupled to the MAC module, receiving the data packets to perform networking operations;
an application specific integrated circuit (ASIC), coupled to the baseband module, MAC module and processor, performing a power saving mode operation; wherein:
when in the power saving mode, the ASIC switches the RF module, baseband module, MAC module and processor to a sleep state;
the ASIC periodically wakes the RF module, baseband module, and MAC module to monitor a beacon frame comprising a TIM field;
the ASIC determines whether the packets are available for reception according to the TIM field; and
if the packets are available, the ASIC wakes the processor to perform the reception operation.

2. The station as claimed in claim 1, wherein if the beacon frame is not received within a timeout interval, the ASIC wakes the processor to handle the timeout event.

3. The station as claimed in claim 1, wherein if the TIM field indicates that a unicast packet is available for reception, the ASIC wakes the processor, and the processor sends a poll frame to request the unicast packet.

4. The station as claimed in claim 1, wherein:
if the TIM field indicates that a broadcast packet is available for reception, the RF module, baseband module and MAC module receive the broadcast packets, and the ASIC determines whether the broadcast packet matches a specific pattern; and
if the broadcast packet matches the specific pattern, the ASIC wakes the processor to perform corresponding processes.

5. The station as claimed in claim 4, wherein:
if the broadcast packet does not match the specific pattern, the ASIC determines whether the broadcast packet comprises a more-bit set-to 1;
if the more-bit is set to 1, the RF module, baseband module and MAC module continue to receive a successive broadcast packet and the ASIC continue to match the specific pattern therewith.

6. The station as claimed in claim 5, wherein if the more-bit is set to 0, the RF module, baseband module and MAC module return to the sleep state.

7. A power saving method for a station in WLAN to receive packets from an access point, wherein:
the station comprises:
a RF module, demodulating received radio signals into basedband signals;
a baseband module, coupled to the RF module, converting the baseband signals to a bit stream;
a MAC module, coupled to the baseband module, processing the bit stream to obtain data packets;
a processor, coupled to the MAC module, receiving the data packets to perform networking operations; and
an ASIC, coupled to the baseband module, MAC module and processor, performing a power saving mode operation;
the power saving method comprising:
the ASIC switching the RF module, baseband module, MAC module and processor to a sleep state;
the ASIC periodically waking the RF module, baseband module and MAC module to monitor a beacon frame comprising a TIM field,
the ASIC determining whether the packets are available for receipt according to the TIM field; and
if the packets are available for receipt, the ASIC waking the processor to perform the receipt operation.

8. The power saving method as claimed in claim 7, further comprising if the beacon frame is not received within a timeout interval, the ASIC waking the processor to handle the timeout event.

9. The power saving method as claimed in claim 7, further comprising if the TIM field indicates that there are unicast packets available, the ASIC waking the processor to send a poll frame to request the unicast packets.

10. The power saving method,as claimed in claim 7, further comprising:
if the TIM field indicates that a broadcast packet is available for receipt, the RF module, baseband module, and MAC module receiving the broadcast packet, and the ASIC determining whether the broadcast packet matches a specific pattern; and
if the broadcast packet matches the specific pattern, the ASIC waking the processor to perform corresponding processes.

11. The power saving method as claimed in claim 10, further comprising:
if the broadcast packet does not match the specific pattern, the ASIC determining whether the broadcast packet comprises a more-bit set to 1; and
if the more-bit is set to 1, the process returning to the RF module, baseband module, and MAC module receiving the broadcast packet and the ASIC matching the specific pattern therewith.

12. The power saving method as claimed in claim 11, further comprising if the more-bit is set to 0, the process returning to the ASIC switching the RF module, baseband module, and MAC module to the sleep state.
